(19) United States
(12) Patent Application Publication
(10) Pub. No.: US 2003/0087619 A1
(43) Pub. Date: May 8, 2003

(54) Frequency conversion circuit having a low phase noise

(75) Inventors: Takashi Maruyama, Fukushima-ken (JP); Rod MacPherson, Buckinghamshire (GB)

Correspondence Address: Brinks Hofer Gilson & Lione, P. O. Box 10395, Chicago, IL, 60610, US

(73) Assignee: Alps Electric Co., Ltd.

(21) Appl. No.: 10/289,625

(22) Filed: Nov. 7, 2002

(30) Foreign Application Priority Data
Nov. 8, 2001 (JP) 2001-343802

(51) Int. Cl. H04B 1/06; H04B 7/00

(52) U.S. Cl. 455/260; 455/314

(57) ABSTRACT

A frequency conversion circuit includes a plurality of mixers coupled to a plurality of local oscillators. A plurality of phase lock loop circuits control the local oscillation frequencies of the local oscillators. Preferably, the local oscillators oscillate at intervals or step frequencies set or programmed by the PLL circuits.

### BACKGROUND

1. Field of the Invention

The present invention relates to a frequency conversion circuit used in an up-line transmitter in a two-way radio link.

2. Description of the Related Art

A frequency conversion circuit having three stages is shown in FIG. 2. A first mixer 21 within the first stage receives a 10 MHz input signal and a local oscillation signal. The local oscillation signal is sourced from a first local oscillator 22. The 10 MHz input signal is received from a viewer. A first PLL circuit 23 controls the first local oscillator 22 which is locked at a constant 40 MHz oscillation frequency. The first mixer 21 produces a signal that is filtered by a 50 MHz bandpass filter 25.

A second mixer 24 within the second stage is cascaded to the first mixer 21 through a bandpass filter 25. The second mixer 24 receives the signal passed by the 50 MHz bandpass filter 25 and a local oscillation signal received from a second local oscillator 26. A second PLL circuit 27 controls the second local oscillator 26 by locking the oscillation frequency to a constant 1000 MHz. The second mixer 24 produces a signal that is filtered by a 950 MHz bandpass filter 29.

A third mixer 28 within the third stage is cascaded to the second stage mixer 24 through a bandpass filter 29. The third mixer 28 receives a signal passed by the 950 MHz bandpass filter and a local oscillation signal generated by a third local oscillator 30. A third PLL circuit 31 controls the third local oscillator 30 that generates frequencies within a 1350 MHz to 1850 MHz range spaced apart in 0.125 MHz increments. The third mixer 28 passes signal frequencies within a 400 MHz to 900 MHz range. The frequency increment of the output signals is 0.125 MHz, which is the step frequency of the third PLL circuit 28.

A microprocessor 32 controls the PLL circuits 23, 27, and 31. The signal frequencies passed by the third stage mixer 28 are set by the data received by the microprocessor 32.

The frequency conversion circuit described above produces signal frequencies that range from 400 MHz to 900 MHz spaced apart in 0.125 MHz increments. Unfortunately, the narrow frequency interval produces phase noise. The phase noise is determined by the relationship between the third local oscillation frequency and the step frequency of the third PLL circuit. The relationship can be quantified by the logarithm of the ratio of the step frequency S and the local oscillation frequency F (=F/S). As the local oscillation frequency “F” increases, the phase noise increases.

In the foregoing configuration, the frequency of the third local oscillator is the highest; moreover, the step frequency of the corresponding third PLL circuit 31 is the step frequency of the output signal. Thus, the above ratio becomes equal to 10800 (=1350/0.125) which indicates that even at a low frequency, the phase noise can be relatively significant.

### SUMMARY

A frequency conversion circuit embodiment includes a plurality of mixers and a plurality of local oscillators. The frequency conversion circuit further includes a plurality of phase lock loop (PLL) circuits that control the local oscillation frequencies of the local oscillators each corresponding to a respective local oscillator. Preferably, each local oscillator oscillates at step intervals set by their respective PLL circuits, and the magnitude of the local oscillation frequencies is or about coincident with the magnitude of the step frequencies.

Further, each local oscillator preferably correspond to a phase lock loop (“PLL”) circuit. Preferably, the local oscillator is programmed or set to a minimum step frequency controlled by the PLL circuits so that the oscillator output varies within a predetermined frequency range.

In some embodiments, a step frequency interval of one PLL circuit corresponding to a first stage mixer is preferably programmed or set to a minimum step frequency interval in comparison to the other mixers.

### BRIEF DESCRIPTION OF THE DRAWINGS

FIG. 1 is a block diagram illustrating a frequency conversion circuit embodiment; and

FIG. 2 is a block diagram illustrating a conventional-frequency conversion circuit.

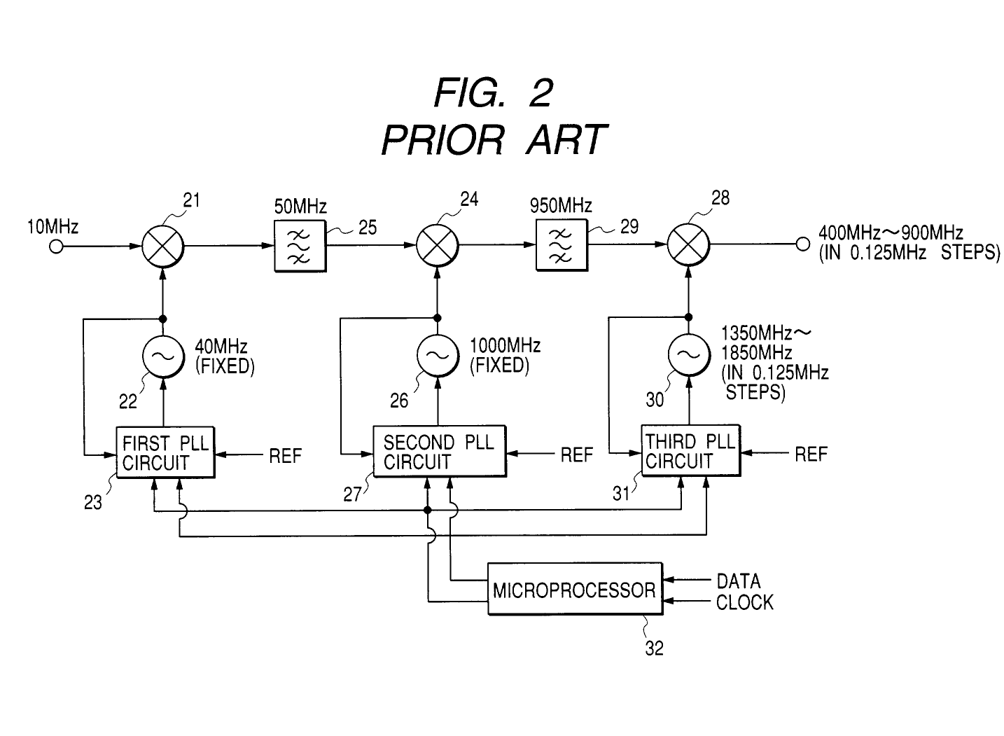

### DESCRIPTION OF THE PRESENTLY PREFERRED EMBODIMENTS

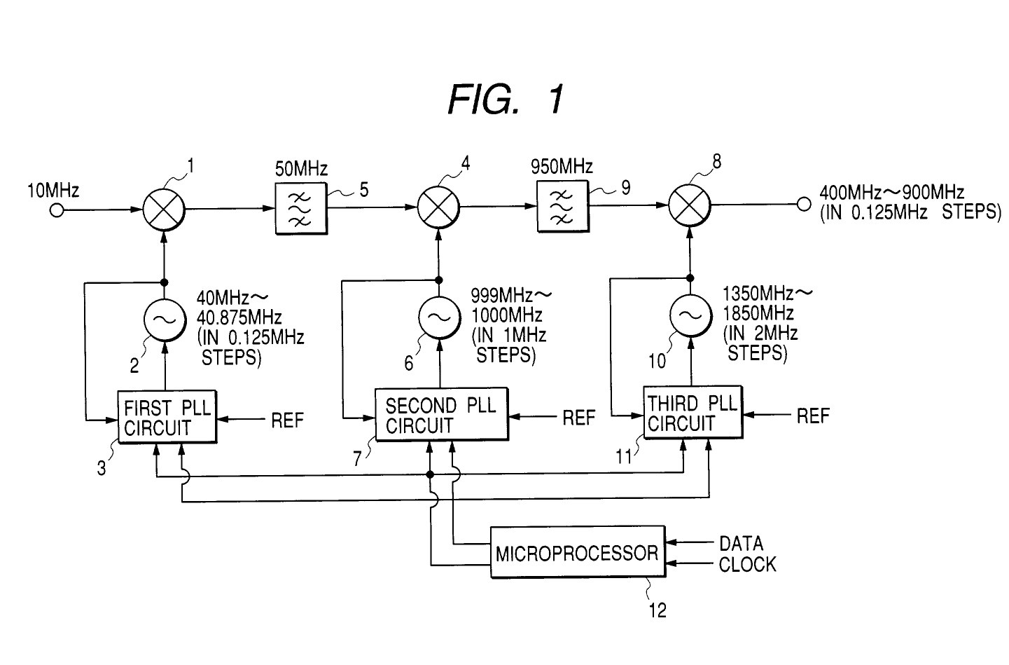

A frequency conversion circuit embodiment is shown in FIG. 1. The frequency conversion circuit is preferably comprised of three stages. A first stage includes a first stage mixer 1 that receives a 10 MHz signal and a local oscillation signal from a first local oscillator 2. A first PLL circuit 3 controls the first local oscillator 2 such that the first local oscillator 2 produces a signal that oscillates within a frequency range of or about 40 MHz to about 40.875 MHz spaced apart at about 0.125 MHz steps.

Preferably, the first stage mixer 1 translates the input signal into two output signals, one at an up-conversion frequency band, and another at a down conversion frequency band. At the up-conversion frequency band the input signal is converted to a conversion frequency range of about 50-50.875 MHz spaced apart at abut 0.125 MHz intervals.

Preferably, a second stage mixer 4 is coupled to the first stage mixer 1 through a bandpass filter 5. The bandpass filter 5 is used to select the up-conversion frequency band translated by the first stage mixer 1. In this embodiment, the second stage mixer 4 receives signals within the frequency range or band that extends between about 50 MHz through about 50.875 MHz. Preferably, the second stage mixer also receives a local oscillation signal produced by a second local oscillator 6. Preferably, the first, second, and third local oscillators are circuits that produce a periodically varying output at a controlled frequency.

A second PLL circuit 7 controls the second local oscillator 6 such that the second local oscillator 6 produces a signal within a frequency range of about 999 MHz - 1000 MHz. This frequency range is then mixed with the selected frequency component passed by the first band pass filter 25. In this embodiment, the second stage mixer 4 produces two frequency translated ranges, one at an up-conversion frequency band and one at a down-conversion frequency band. Signals within the down-conversion frequency band preferably range from about 949-950 MHz spaced apart at about 1. MHz intervals.

Preferably, a third stage mixer 8 is coupled to the second stage mixer 4 through a second bandpass filter 9. The third stage mixer 8 receives a signal converted into about 950 MHz frequency signal and also receives a local oscillation signal from the third local oscillator 10. A third PLL circuit 11 controls the third local oscillator 10 such that the third local oscillator produces a signal that oscillates at a frequency range from about 1350-1850 MHz spaced apart at about 2 MHz step intervals.

Preferably, the third stage mixer 8 produces signals at an up-conversion frequency band and a down-conversion frequency band. As shown in FIG. 1, signals within the down-conversion band preferably range from about 400 MHz to about 900 MHz. The frequency interval of the produced signals, the output, preferably vary by about 0.125 MHz steps.

A microprocessor 12 controls the first, second, and third PLL circuits 3, 7, 11 each, and the signal frequencies generated by the third stage mixer 8 are set or programmed based at least in part on the data the microprocessor 2 receives.

Table 1 illustrates the relations between the oscillation frequency of the first local oscillator 2 (first local oscillation frequency OSC1), the oscillation frequency of the second local oscillator 6 (second local oscillation frequency OSC2), and the oscillation frequency of the third local oscillator 10 (third local oscillation frequency OSC3) against the down-conversion signal frequency band produced by the third stage mixer 8 (output frequency OUT).

TABLE 1

| OUT | OSC1 | OSC2 | OSC3 |
|---|---|---|---|
| 400.000 | 40.000 | 1000.000 | 1350.000 |
| 400.125 | 40.125 | | |
| . | . | ↓ | ↓ |
| . | . | | |
| . | . | | |
| 400.875 | 40.875 | 999.000 | |
| 401.000 | 40.000 | | |
| 401.125 | 40.125 | | |
| . | . | ↓ | |
| . | . | | |
| . | . | | |
| 401.875 | 40.875 | 1000.000 | 1352.000 |
| 402.000 | 40.000 | | |
| 402.125 | 40.125 | | |
| | | ↓ | ↓ |
| 899.875 | 40.875 | 1000.000 | 1850.000 |
| 900.000 | 40.000 | 999.000 | 1850.000 |
| 0.125 MHz steps | 0.125 MHz steps | 1 MHz steps | 2 MHz steps |

If the output frequency of the third stage mixer 8 (OUT) is about 400 MHz, the first local oscillation frequency (OSC1) through the third local oscillation frequency (OSC3) will be about 40 MHz, 1000 MHz, 1350 MHz, respectively. As the output frequency (OUT) increases, the first local oscillation frequency (OSC1) increases at about 0.125 MHz intervals. When the output frequency (OUT) is increased just by about 1 MHz to reach 401 MHz, the first local oscillation frequency (OSC1) is reset to about 40 MHz and the second local oscillation frequency (OSC2) is decreased by about 1 MHz and reset to about 999 MHz.

In the same manner, until the output frequency (OUT) increases to about 401.875 MHz, the first local oscillation frequency (OSC1) increases in about 0.125 MHz steps. When the output frequency (OUT) is increased exactly to 402 MHz, the first local oscillation frequency (OSC1) is reset to about 40 MHz, and also the second local oscillation frequency (OSC2) is reset to about 1000 MHz. In this configuration, the third local oscillation frequency (OSC3) is preferably reset to about 1352 MHz, which is about 2 MHz higher than the original oscillation frequency.

As described above, each time the output frequency (OUT) increases by about 1 MHz, the first local oscillation frequency (OSC1) is reset repeatedly, and the second local oscillation frequency (OSC2) is reset to about 1000 MHz and 999 MHz alternately and repeatedly. The third local oscillation frequency (OSC3) is increased in about 2 MHz steps each time the output frequency (OUT) increases by about 2 MHz.

According to the relation of the above-described local oscillation frequencies, the output frequency (OUT) is set or programmed to any one frequency within a range from about 400 MHz through about 900 MHz spaced apart in about 0.125 MHz steps.

In this embodiment, the ratio of the oscillation frequency and the step frequency in the first local oscillator 2 is about 320 (=40/0.125), the ratio of the oscillation frequency and the step frequency in the second local oscillator 6 is preferably about 1000 (=1000/1), and the ratio of a medium value of the oscillation frequency and the step frequency in the third local oscillator 10 is about 800 (=1600/2); and the overall ratio is the sum of these ratios, which is about 2120. In this embodiment, the sum is equivalent to about 20% or (about ⅕) of the conventional ratio of the step frequency and the local oscillation frequency described in the Related Art. Accordingly, the phase noise is remarkably improved.

As described above, the frequency conversion circuit includes a plurality of cascaded mixers and a plurality of local oscillators coupled to the mixers that supply local oscillation signals to each of the mixers. Further, the frequency conversion circuit includes a plurality of PLL circuits that control local oscillation frequencies of the local oscillators. In one embodiment, the local oscillators are programmed or set to produce a periodically varying output at intervals or at step frequencies set by the individual PLL circuits. Preferably, the order of magnitude of the local oscillation frequencies is at or about coincident with the order of magnitude of the step frequencies which reduces phase noise.

Since the oscillators corresponding to each of the PLL circuit are set or programmed to the minimum step frequency of the PLL circuits, the oscillators produce a periodically varying output within a predetermined frequency range. Preferably, the final stage mixer is capable of driving signals at the interval of a minimum step frequency.

Also since the interval of the step frequencies of the PLL circuit corresponding to the first stage mixer is set or programmed to the minimum interval received by any of the mixers, the frequency of the oscillating signal received by the final stage mixer can be at a higher frequency than that of the oscillating signal received by the first stage mixer.

The above described embodiments can be used in many applications. The first, second, and third PLL circuits and the other circuits can be realized using analog or digital circuits. Likewise, the mixers or multipliers can be implemented using a single balanced or a double balanced mixers. The mixer circuits may also be implemented such that the input spectrum has been translated up or down depending on a pass band of an integral unitary output filter of the mixer.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A frequency conversion circuit comprising
a plurality of mixers;
a plurality of local oscillators, each of the local oscillators supplying a local oscillation signal to one of the plurality of mixers; and
a plurality of phase lock loop circuits, each of the phase lock loop circuits being coupled to one of the local oscillators;
wherein each of the local oscillators are programmed to produce an output at step frequency intervals that correspond to each of the phase lock loop circuits that each local oscillator is coupled to, and an order of magnitude of local oscillation frequencies is about coincident with an order of magnitude of the step frequencies.

2. The frequency conversion circuit according to claim 1, wherein at least one local oscillator is set to a minimum step frequency of one of the phase lock loop circuits.

3. The frequency conversion circuit according to claim 2, wherein each of the local oscillators produce a varying output that varies by controlled incremental frequencies.

4. A frequency conversion circuit comprising
a plurality of mixers;
a plurality of local oscillators, each of the local oscillators being coupled to one of the plurality of mixers; and
a plurality of PLL circuits, each of the PLL circuits being coupled to one of the plurality of local oscillators;
wherein each of the local oscillators are programmed to oscillate at differing step frequencies that correspond to one of the PLL circuits.

5. The frequency conversion circuit according to claim 4, wherein a first local oscillator is programmed to a minimum step frequency by a PLL circuit.

6. The frequency conversion circuit according to claim 5, wherein an interval of one of the step frequencies of the PLL circuit is greater than or about equal to one megahertz.

7. A frequency conversion circuit comprising
a first stage;
a second stage;
a third stage; and
a plurality of filters coupling the first stage to the second stage to the third stage;
wherein each of the stages comprise a phase lock loop coupled to an oscillator coupled to a mixer;
wherein each oscillator is programmed to oscillate at different step frequencies that correspond to the phase lock loop circuit within each stage.

8. The frequency conversion circuit of claim 7 wherein each of the oscillators are configured to produce a varying output at a controlled frequency that varies by a constant frequency interval.

9. The frequency conversion circuit of claim 8 wherein the filters comprise bandpass filters.

10. The frequency conversion circuit of claim 9 wherein a pass band of a first band pass filter selectively passes an up-conversion band of a first mixer.

11. The frequency conversion circuit of claim 9 wherein a pass band of a second band pass filter selectively passes a down-conversion band of a second mixer.

12. The frequency conversion circuit of claim 10 further including a processor coupled to the first, the second, and the third stages.
